(19) United States
(12) Patent Application Publication
(10) Pub. No.: US 2009/0191463 A1
(43) Pub. Date: Jul. 30, 2009

(54) NEGATIVE ELECTRODE FOR NONAQUEOUS SECONDARY BATTERY

(76) Inventors: Hitohiko Ide, Saitama (JP); Akihiro Modeki, Saitama (JP); Hideaki Matsushima, Saitama (JP); Daisuke Mukai, Saitama (JP); Kiyotaka Yasuda, Saitama (JP)

Correspondence Address: YOUNG & THOMPSON, 209 Madison Street, Suite 500, ALEXANDRIA, VA, 22314, US

(21) Appl. No.: 12/306,990

(22) PCT Filed: Apr. 18, 2007
(86) PCT No.: PCT/JP2007/058414

§ 371 Date: Dec. 30, 2008

(30) Foreign Application Priority Data
Jun. 30, 2006 (JP) 2006-182802
Mar. 19, 2007 (JP) 2007-069923

(51) Int. Cl. H01M 4/58; H01M 4/29

(52) U.S. Cl. 429/231.95; 205/59

(57) ABSTRACT

A negative electrode 10 for a nonaqueous secondary battery has an active material layer 12 containing active material particles 12a. The particles 12a are coated at least partially with a coat of a metallic material 13 having low capability of lithium compound formation. The active material layer 12 has voids formed between the metallic material-coated particles 12a. When the active material layer 12 is imaginarily divided into equal halves in its thickness direction, the amount of the metallic material 13 is smaller in the half closer to the negative electrode surface than in the other half farther from the negative electrode surface. The weight ratio of [the particles/the metallic material] in the half closer to the negative electrode surface is preferably higher than that in the other half farther from the negative electrode surface.

### TECHNICAL FIELD

This invention relates to a negative electrode for a nonaqueous secondary battery.

### BACKGROUND ART

Assignee of the present invention previously proposed in Patent Document 1 a negative electrode for a nonaqueous secondary battery having a pair of current collecting surface layers of which the surfaces are brought into contact with an electrolyte and an active material layer interposed between the surface layers. The active material layer contains a particulate active material having high capability of forming a lithium compound. A metallic material having low capability of forming a lithium compound is present over the whole thickness of the active material layer such that the active material particles exist in the penetrating metallic material. Owing to the structure of the active material layer, even if the active material particles pulverize as a result of repeated expansion and contraction accompanying charge and discharge cycles, there is less likelihood of the particles falling off the negative electrode. Thus, the proposed negative electrode provides the advantage of an extended battery life.

In order for the particles in the active material layer to successfully absorb and release lithium ions, it is necessary to allow a nonaqueous electrolyte containing lithium ions to pass through the active material layer smoothly. For this, it is advantageous to provide flow paths through which a nonaqueous electrolyte can be supplied in the active material layer. However, when the amount of the above-described penetrating metallic material in the active material layer is too much, formation of the paths is insufficient so that the lithium ions are hardly allowed to reach inside the active material layer. As a result, the resulting negative electrode tends to have a high overpotential in the initial charge. A high overpotential can cause formation of lithium dendrite on the negative electrode surface and decomposition of the nonaqueous electrolyte. Conversely, when the amount of the penetrating metallic material is too little, the adhesion between the active material layer and the current collector is insufficient.

Patent Document 1 US 2006-115735A1

Accordingly, an object of the invention is to provide a negative electrode for a nonaqueous secondary battery with further improved performance over the above-described conventional technique.

### DISCLOSURE OF THE INVENTION

The invention provides a negative electrode for a nonaqueous secondary battery comprising an active material layer containing particles of an active material,

the particles being coated at least partially with a coat of a metallic material having low capability of forming a lithium compound,

the active material layer having voids formed between the metallic material-coated particles,

wherein, when the active material layer is imaginarily divided into equal halves in its thickness direction, the amount of the metallic material is smaller in the half closer to the negative electrode surface than in the other half farther from the negative electrode surface.

The invention also provides a process of producing a negative electrode for a nonaqueous secondary battery comprising the steps of:

applying a slurry containing particles of an active material to a current collector to form a coating layer,

immersing the current collector with the coating layer in a plating bath containing a metallic material having low capability of forming a lithium compound and performing electroplating at a first current density to deposit the metallic material within the coating layer, and then

performing electroplating at a second current density higher than the first current density.

### BRIEF DESCRIPTION OF THE DRAWINGS

FIG. 1 schematically illustrates a cross-sectional structure of an embodiment of the negative electrode for a nonaqueous secondary battery according to the invention.

FIG. 2(a) and FIG. 2(b) are each a schematic enlarged view of the active material layer in the negative electrode illustrated in FIG. 1.

FIG. 3a, FIG. 3b, FIG. 3c, and FIG. 3d are diagrams showing a process of producing the negative electrode shown in FIG. 1.

FIG. 4 is a graph showing Raman spectra measured in the thickness direction of an active material layer in the negative electrodes obtained in Example and Comparative Examples.

### DETAILED DESCRIPTION OF THE INVENTION

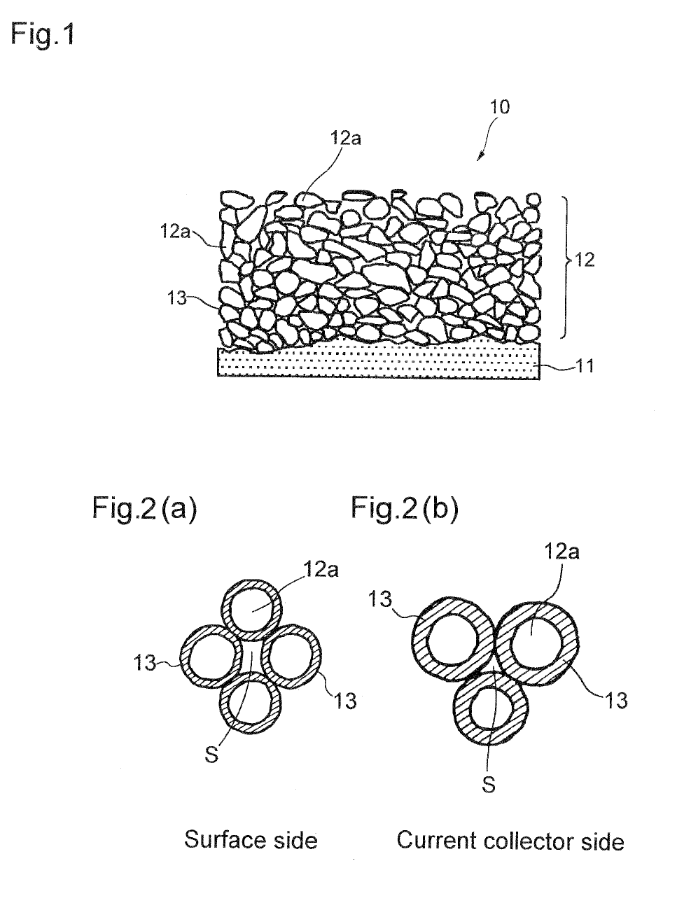

The present invention will be illustrated based on its preferred embodiment with reference to the accompanying drawing. FIG. 1 is a schematic cross-sectional view of a preferred embodiment of the negative electrode for a nonaqueous secondary battery according to the invention. The negative electrode 10 of the present embodiment has a current collector 11 and an active material layer 12 on at least one side of the current collector 11. Although FIG. 1 shows only one active material layer 12 for the sake of convenience, the active material layer may be provided on both sides of the current collector 11.

The active material layer 12 contains particles 12a of an active material. The active material layer 12 is formed, for example, by applying a slurry containing the particles 12a of an active material. The active material is exemplified by silicon based materials, tin based materials, aluminum based materials, and germanium based materials. An exemplary and preferred tin based material as an active material is an alloy composed of tin, cobalt, carbon, and at least one of nickel and chromium. A silicon based material is particularly preferred to provide an improved capacity density per weight of a negative electrode.

Examples of the silicon based material include materials containing silicon and capable of absorbing lithium, such as elemental silicon, alloys of silicon and metal element(s), and silicon oxides. These materials may be used either individually or as a mixture thereof. The metal making the silicon alloy is one or more elements selected from, for example, Cu, Ni, Co, Cr, Fe, Ti, Pt, W, Mo, and Au. Preferred of these elements are Cu, Ni, and Co, Cu and Ni are more preferred in terms of their high electron conductivity and low capability of forming a lithium compound. The silicon based material as an active material may have lithium absorbed either before or after assembling the negative electrode into a battery. A particularly preferred silicon based material is elemental silicon or silicon oxide for its high lithium absorption capacity.

In the active material layer 12, the particles 12a are coated at least partially with a metallic material 13 having low capability of forming a lithium compound. The metallic material 13 is different from the material making up the particles 12a. There are voids formed between the metallic material-coated particles 12a. That is, the metallic material covers the surface of the particles 12a while leaving interstices through which a nonaqueous electrolyte containing lithium ions may reach the particles 12a. In FIG. 1, the metallic material 13 is depicted as a thick solid line defining the perimeter of the individual particles 12a for the sake of clarify of the drawing. FIG. 1 is a two-dimensionally schematic illustration of the active material layer 12 so that some of the particles 12a in the active material layer 12 are depicted with no contact with the neighboring particles. In fact, the individual particles are in contact with one another either directly or via the metallic material 13. As used herein, the expression “low capability of forming a lithium compound” means no capability of forming an intermetallic compound or a solid solution with lithium or, if any, the capability is so limited that the resulting lithium compound contains only a trace amount of lithium or is unstable.

It is preferred that the metallic material 13 on the surface of the active material particles 13a is present throughout the thickness of the active material layer 12 in a manner that the particles 12a exist in the matrix of the metallic material 13. By such a configuration, the particles 12a hardly fall off even when they pulverize due to expansion and contraction accompanying charge/discharge cycles. Furthermore, electron conductivity across the active material layer 12 is secured by the metallic material 13 so that occurrence of an electrically isolated particle 12a, especially in the depth of the active material layer 12, is prevented effectively. This is particularly advantageous in the case where a semiconductive, poorly electron-conductive active material, such as a silicon based material, is used as an active material. Whether the metallic material 13 is present throughout the thickness of the active material layer 12 can be confirmed by mapping the metallic material 13 using an electron microscope.

The metallic material 13 covers the surface of the individual particles 12a continuously or discontinuously. Where the metallic material 13 covers the surface of the individual particles 12a continuously, it is preferred that the coat of the metallic material 13 has micropores for the passage of a nonaqueous electrolyte. Where the metallic material 13 covers the surface of the individual particles 12a discontinuously, a nonaqueous electrolyte is supplied to the particles 12a through the non-coated part of the surface of the particles 12a. Such a coat of the metallic material 13 is formed by, for example, depositing the metallic material 13 on the surface of the particles 12a by electroplating under the conditions described infra.

There are voids formed between the particles 12a coated with the metallic material 13. The voids serve as a flow passage for a nonaqueous electrolyte containing lithium ions. The voids allow the nonaqueous electrolyte to easily reach the active material particles 12a, whereby the overpotential in initial charge can be reduced. As a result, formation of lithium dendrite on the negative electrode surface, which can cause a short circuit, is prevented. Reduction of overpotential is also advantageous in that decomposition of the nonaqueous electrolyte, which causes an increase of irreversible capacity, is prevented. Reduction of overpotential is also beneficial to protect the positive electrode from damage. The details of the voids formed between the particles 12a will be described later.

The voids formed between the particles 12a also afford vacant spaces to serve to relax the stress resulting from volumetric changes of the active material particles 12a accompanying charge and discharge cycles. The volume gain of the active material particles 12a resulting from charging is absorbed by the voids. Therefore, the particles 12a are less liable to pulverize, and noticeable deformation of the negative electrode 10 is avoided effectively.

When the active material layer 12 of the negative electrode 10 of the present embodiment is imaginarily divided into equal halves in its thickness direction, the amount of the metallic material 13 is smaller in the half closer to the negative electrode surface than in the other half that is farther from the negative electrode surface. While the term “amount” as used with respect to the metallic material 13 means “weight”, replacing “weight” with “volume” makes no essential difference. In the present embodiment it is preferred that the amount of the metallic material 13 in the half closer to the negative electrode surface is in the range of from 20% to 90%, more preferably from 30% to 80%, even more preferably from 50% to 75%, of that in the other half that is farther from the negative electrode surface. While varying according to the metallic material 13, the amount of the metallic material 13 in the half closer to the negative electrode surface is preferably 0.5 to 3 g/cm³, more preferably 1 to 2 g/cm³, and that in the half farther from the negative electrode surface is preferably 2 to 6 g/cm³, more preferably 3 to 4 g/cm³. The half of the active material layer that is closer to the negative electrode surface will hereinafter be referred to as a surface side active material sublayer, and the other half that is farther from the negative electrode surface will hereinafter be referred to as a current collector side active material sublayer.

The particles 12a are distributed almost uniformly in the thickness direction of the active material layer 12. Accordingly, the fact that the amount of the metallic material 13 present in the surface side active material sublayer is smaller than that in the current collector side active material sublayer means that the thickness of the metallic material 13 covering the particles 12a in the surface side active material sublayer is smaller than that in the current collector side active material sublayer. This will be described in more detail by referring to FIGS. 2(a) and 2(b).

FIG. 2(a) is a schematic enlarged illustration of the surface side active material sublayer, while FIG. 2(b) is a schematic enlarged illustration of the current collector side active material sublayer. As illustrated, the metallic material 13 covering the particles 12a in the surface side active material sublayer is thinner than that in current collector side active material sublayer. As a result, the void S left between the particles 12a is larger in size in the surface side active material sublayer than in the current collector side active material sublayer. In other words, the surface side of the active material layer 12 is in a condition ready to let in a nonaqueous electrolyte. Besides, voids necessary and sufficient for the passage of a nonaqueous electrolyte are formed inside the active material layer 12 as stated supra. Thus, the active material layer 12 in the negative electrode 10 of the present embodiment has such a structure that lets in a nonaqueous electrolyte easily and allows the entering nonaqueous electrolyte to penetrate in its thickness direction smoothly. The negative electrode 10 of the present invention therefore achieves a further reduced overpotential in the initial charge.

Moreover, the fact that the amount of the metallic material in the current collector side active material sublayer is larger than in the surface side active material sublayer as illustrated in FIG. 2(b) enhances the adhesion of the active material layer 12 to the current collector. This is advantageous in that the active material layer 12 is less liable to separate from the current collector even when the active material layer 12 undergoes deformation with expansion and contraction of the particles 12a accompanying charge and discharge cycles.

The amount of the metallic material 13 in each of the surface side active material sublayer and the current collector side active material sublayer is determined by, for example, the following method. The total amount of the active material 13 in the active material layer 12 is measured with an ICP-AES apparatus. A vertical cross-section of the active material layer 12 is then analyzed with an energy dispersive X-ray spectroscopy (EDX) analyzer to measure a ratio of the metallic material 13 in the surface side active material sublayer 12S to that in the current collector side active material sublayer 12C. The amount of the metallic material 13 in each of the surface side active material sublayer 12S and the current collector side active material sublayer 12C is then calculated from the total amount of the metallic material 13 in the active material layer 12 and the ratio of the metallic material 13 of the two sublayers.

As previously stated, the active material particles 12a are distributed practically uniformly in the thickness direction of the active material layer 12. The density gradient of the particles 12a in the thickness direction of the active material layer 12 is preferably 30% or less. Accordingly, the particles 12a to metallic material 13 weight ratio in the surface side active material sublayer is higher than that in the current collector side active material sublayer. Specifically, the particles 12a to metallic material 13 weight ratio in the surface side active material sublayer is preferably 1.05 to 5 times, more preferably 1.1 to 4.5 times, even more preferably 1.2 to 3.5 times, that in the current collector side active material sublayer. The weight ratio is determined by analyzing a vertical cross-section of the active material layer 12 with an EDX analyzer.

The thickness of the metallic material 13 covering the individual particles 12a, which is smaller in the surface side active material sublayer than in the current collector side active material sublayer as above mentioned, may vary in the thickness direction of the active material layer 12 either continuously or stepwise. That is, the thickness of the coat of the metallic material 13 may increase continuously or stepwise in the active material layer 13 from the surface toward the interface with the current collector. The thickness of the coat of the metallic material 13 is measured for example by observing a vertical cross-section of the active material layer 12 with an SEM.

In relation to the above, the size of the voids formed between the particles 12a may vary along the thickness direction of the active material layer 12 either continuously or stepwise. In more detail, the size of the voids may decrease continuously or stepwise from the surface of the active material layer 12 toward the current collector. The size of the voids can be measured by for example observing a cross-section of the active material layer 12 with an SEM.

The thickness of the metallic material 13 covering the surface of the active material particles 12a is preferably as thin as 0.05 to 2 μm, more preferably 0.05 to 0.5 μm, in each of the surface side active material sublayer and the current collector side active material sublayer with proviso that the thickness differs between the two sublayers. The metallic material 13 thus preferably covers the active material particles 12a with this minimum thickness, thereby to prevent falling-off of the particles 12a having pulverized as a result of expansion and contraction accompanying charge/discharge cycles while improving the energy density. As used herein the term “average thickness” denotes an average calculated from the thicknesses of the metallic material coat 13 actually covering the surface of the particle 12a. The non-coated part of the surface of the particle 12a by the metallic material 13 is excluded from the basis of calculation.

As described below, The active material layer 12 is preferably formed by applying a slurry containing the particles 12a and a binder to a current collector, drying the applied slurry to form a coating layer, and electroplating the coating layer in a plating bath having a prescribed composition to deposit a metallic material 13 between the particles 12a.

To form necessary and sufficient voids in the active material layer 12 through which a nonaqueous electrolyte passes, it is preferred that a plating bath thoroughly penetrates the coating layer. In addition to this, it is preferred that the conditions for depositing the metallic material 13 by electroplating using the plating bath be properly selected. Such conditions include the composition and pH of the plating bath and the electrolytic current density. The pH of the plating bath is preferably 7.1 to 11. With a plating bath having a pH in that range, the surface of the active material particles 12a is cleaned (while dissolution of the particles 12a is suppressed), which accelerates deposition of the metallic material 13 thereon, while leaving moderate voids between the particles 12a. The pH value as referred to herein is as measured at the plating temperature.

In plating with copper as a metallic material 13, a copper pyrophosphate plating bath is preferably used. In using nickel as a metallic material, an alkaline nickel bath, for example, is preferably used. To use a copper pyrophosphate plating bath is advantageous in that the aforementioned voids can easily be formed throughout the thickness of the active material layer 12 even when the active material layer 19 has an increased thickness. Using a copper pyrophosphate bath offers an additional advantage that the metallic material 13, while being deposited on the surface of the active material particles 12a, is hardly deposited between the particles 12a so as to successfully leave voids located between the particles 12a. In using a copper pyrophosphate bath, a preferred composition and pH of the bath and preferred electrolysis conditions are as follows.
Copper pyrophosphate trihydrate: 85-120 g/l
Potassium pyrophosphate: 300-600 g/l
Potassium nitrate: 15-65 g/l
Bath temperature: 45-60° C.
Current density: 1-7 A/dm²
pH: adjusted to 7.1 to 9.5, by the addition of aqueous ammonia and polyphosphoric acid.

When in using a copper pyrophosphate bath, the bath preferably has a weight ratio of P₂O₇ to Cu, P₂O₇/Cu (hereinafter referred to as a P ratio), of 5 to 12. With a bath having a P ratio less than 5, the metallic material covering the active material particles 12a tends to be thick, which can make it difficult to secure voids as expected between the active material particles 12a. With a bath having a P ratio more than 12, the current efficiency is deteriorated, and gas generation tends to accompany, which can result in reduced stability of production. A still preferred P ratio of a copper pyrophosphate plating bath is 6.5 to 10.5. When a plating bath with the still preferred P ratio is used, the size and the number of the voids formed between the active material particles 12a are very well suited for the passage of a nonaqueous electrolyte in the active material layer 12.

When in using an alkaline nickel bath a preferred composition and pH of the bath and preferred electrolysis conditions are as follows.
Nickel sulfate: 100-250 g/l
Ammonium chloride: 15-30 g/l
Boric acid: 15-45 g/l
Bath temperature: 45-60° C.
Current density: 1-7 A/dm²
pH: adjusted to 8-11 by the addition of 100-300 g/l of 25 wt % aqueous ammonia.

Plating using the copper pyrophosphate bath is preferred to plating using the alkaline nickel plating bath; for the former tends to form adequate voids in the active material layer 12 thereby providing a negative electrode with a prolonged life as compared with the latter plating

Various additives used in an electrolytic solution for the production of copper foil, such as proteins, active sulfur compounds, and cellulose compounds, may be added to the plating bath to appropriately control the characteristics of the metallic material 13.

The active material layer formed by the above mentioned various methods preferably has a void fraction (=porosity) of about 15% to 45%, more preferably about 20% to 40%, by volume. With the void fraction arranging within that range, there are formed voids necessary and sufficient to allow for passage of a nonaqueous electrolyte in the active material layer 12. The void fraction is measured in accordance with the following procedures (1) through (7).

(1) Measure the weight per unit area of a coating layer formed by application of the above described slurry. Calculate the weights of the particles 12a and of the binder from the composition ratio of the slurry.
(2) After electroplating, calculate the weight of the deposited plating metal species from the weight gain per unit area.
(3) After electroplating, observe a cross-section of the resulting negative electrode under an SEM to measure the thickness of the active material layer 12.
(4) Calculate the volume per unit area of the active material layer 12 from the thickness of the active material layer 12.
(5) Calculate the volume each of the particles 12a, the binder, and the plating metal species from their respective weights and the composition ratio of the slurry.
(6) Subtract the volumes per unit area of the particles 12a, the binder, and the plating metal species from the volume per unit area of the active material layer 12 to give the void volume.
(7) Divide the void volume by the volume per unit area of the active material layer 12, and multiply the quotient by 100 to give a percent void fraction.

The void fraction may also be controlled by proper choice of the particle size of the active material particles 12a. From this viewpoint, the particles 12a preferably have a maximum particle size of 30 μm or smaller, more preferably 10 μm or smaller, and an average particle size of 0.1 to 8 μm, more preferably 0.3 to 4 μm, in terms of D₅₀. The particle size measurement is made with a laser diffraction scattering particle size analyzer or an electron microscope (SEM).

When the amount of the active material in the negative electrode is too small, it is difficult to sufficiently increase the energy density. When the amount is too large, the active material is likely to come off. A suitable thickness of the active material layer 12 for these considerations is preferably 10 to 40 μm, more preferably 15 to 30 μm, even more preferably 18 to 25 μm.

The metallic material 13 having low capability of forming a lithium compound and being deposited in the active material layer 12 has electroconductivity and is exemplified by copper, nickel, iron, cobalt, and their alloys. A highly ductile metallic material is preferred, which forms a stable electroconductive metallic network throughout the whole active material layer 12 against expansion and contraction of the active material particle 12a. A preferred example of such a material is copper.

The negative electrode 10 of the present embodiment may or may not have a thin surface layer (not shown in the drawing) on the active material layer 12. The thickness of the surface layer is as thin as 0.25 μm or less, preferably 0.1 μm or less. There is not lower limit to the thickness of the surface layer.

In the absence of a surface layer or in the presence of a very thin surface layer on the negative electrode 10, the overpotential in initial charging of a secondary battery assembled by using the negative electrode 10 can be minimized. This means that reduction of lithium on the surface of the negative electrode 10 during charging the secondary battery is avoided. Reduction of lithium can lead to the formation of lithium dendrite that can cause a short circuit between the electrodes.

In the cases where the negative electrode 10 has a surface layer, the surface layer covers the surface of the active material layer 12 continuously or discontinuously. Where the surface layer continuously covers the active material layer 12, the surface layer preferably has a number of micropores (not shown in the drawing) open on its surface and connecting to the active material layer 12. The micropores preferably extend in the thickness direction of the surface layer. The micropores enable passage of a nonaqueous electrolyte. The role of the micropores is to supply a nonaqueous electrolyte into the active material layer 12. The amount of the micropores is preferably such that when the negative electrode 10 is observed from above under an electron microscope, the ratio of the area covered with the metallic material 13, namely a coating ratio, is not more than 95%, more preferably 80% or less, even more preferably 60% or less.

The surface layer is formed of a metallic material having low capability of forming a lithium compound. The metallic material forming the surface layer may be the same or different from the metallic material 13 present in the active material layer 12. The surface layer may be composed of two or more sublayers of different metallic materials. Taking into consideration ease of production of the negative electrode 10, the metallic material 13 present in the active material layer 12 and the metallic material forming the surface layer are preferably the same.

Any current collector conventionally used in negative electrodes for nonaqueous secondary batteries can be used as the current collector 11 of the negative electrode 10. The current collector 11 is preferably made out of the above-described metallic material having low capability of forming a lithium compound, examples of which are given previously. Preferred of them are copper, nickel, and stainless steel. Copper alloy foil typified by Corson alloy foil is also usable. Metal foil preferably having a dry tensile strength (JIS C2318) of 500 MPa or more, for example, Corson alloy foil having a copper coat on at least one side thereof is also useful. A current collector having dry elongation (JIS C2318) of 4% or more is preferably used. A current collector with low tensile strength is liable to wrinkle due to the stress of the expansion of the active material. A current collector with low elongation tends to crack due to the stress. Using a current collector made of these preferred materials ensures the folding endurance of the negative electrode 10. The thickness of the current collector 11 is not critical in the present embodiment, and is preferably 9 to 35 μm in view of the balance between retention of strength of the negative electrode 10 and improvement of energy density. In the case of using copper foil as a current collector 11, it is recommended to subject the copper foil to anti-corrosion treatment, like chromate treatment or treatment with an organic compound such as a triazole compound or an imidazole compound.

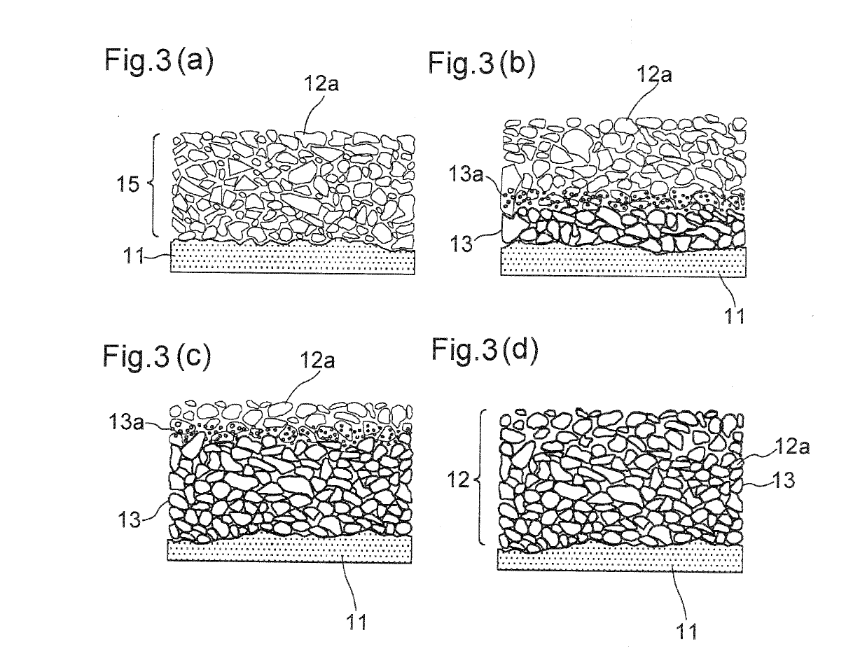

A preferred process of producing the negative electrode 10 of the present embodiment will then be described with reference to FIG. 3. The process includes the steps of forming a coating layer on a current collector 11 using a slurry containing particles of an active material and a binder and subjecting the coating layer to electroplating.

As illustrated in FIG. 3(a), a current collector 11 is prepared, and a slurry containing active material particles 12a is applied thereon to form a coating layer 15. The slurry contains a binder, a diluting solvent, etc. in addition to the active material particles. The slurry may further contain a small amount of particles of an electroconductive carbon material, such as acetylene black or graphite. Where, in particular, the active material particles 12a are silicon-based material particles, it is preferred to add the electroconductive carbon material in an amount of 1% to 3% by weight based on the active material particles 12a. With less than 1% by weight of an electroconductive carbon material, the slurry has a reduced viscosity so that the active material particles 12a cause sedimentation easily in the slurry, which can result in a failure to form a desired coating layer 15 with uniform voids. If the electroconductive carbon material content exceeds 3% by weight, plating nuclei tend to concentrate on the surface of the electroconductive carbon material, which can also result in a failure to form a desired coating layer.

Examples of the binder include styrene-butadiene rubber (SBR), polyvinylidene fluoride (PVDF), polyethylene (PE), and ethylene-propylene-diene monomer (EPDM). Examples of the diluting solvent include N-methylpyrrolidone and cyclohexane. The slurry preferably contains about 30% to 70% by weight of the active material particles 12a and about 0.4% to 4% by weight of the binder. A diluting solvent is added to these materials to prepare the slurry.

The coating layer 15 thus formed has fine vacant spaces between the particles 12a. The current collector 11 with the coating layer 15 is then immersed in a plating bath containing a metallic material having low capability of forming a lithium compound. Whereupon, the plating bath infiltrates into the vacant spaces and reaches the interface between the coating layer 15 and the current collector 11. In this state, electroplating is conducted to deposit the plating metal species on the surface of the particles 12a (we call electroplating of this type “penetration plating”). Penetration plating is performed by immersing the current collector 11 as a cathode and a counter electrode (anode) in the plating bath and connecting the two electrodes to a power source.

It is preferred to have the metallic material deposited in a direction from one side to the opposite side of the coating layer 15. Specifically, electroplating is carried out in a manner such that deposition of the metallic material 13 proceeds from the interface between the coating layer 15 and the current collector 11 toward the surface of the coating layer 15 as illustrated in FIGS. 3(b) through 3(d). By causing the metallic material 13 to be deposited in that way, the degree of the deposition of the metallic material can be varied easily between the side close to the surface and the side close to the current collector 11. Moreover, the active material particles 12a are successfully coated with the metallic material 13; voids are successfully formed between the metallic material-coated particles 12a coated with the metallic material 13; and, in addition, the above-recited preferred range of the void fraction (porosity) is achieved easily.

The conditions of penetration plating for depositing the metallic material 13 as described above include the composition and pH of the plating bath and the electrolytic current density, which have been described supra.

As shown in FIG. 3(b), when electroplating is carried out in a manner such that deposition of the metallic material 13 proceeds from the interface between the coating layer 15 and the current collector 11 to the surface of the coating layer, there always are microfine particles 13a comprising plating nuclei of the metallic material 13 in a layer form with an almost constant thickness along the front of the deposition reaction. With the progress of the deposition of the metallic material 13, neighboring microfine particles 13a gather into larger particles, which, with further progress of the deposition, gather one another to continuously coat the surface of the active material particles 12a.

At the time when the penetration plating proceeds up to the height of about a lower half of the coating layer 15, the plating condition is altered to such a condition so as to result in a smaller thickness of the coat of the metallic material 13, under which condition the penetration plating is continued as illustrated in FIG. 3(c). By this operation, the amount of the metallic material 13 in about the upper half of the coating layer 15 can be made smaller than that in about the lower half. Alteration of the plating condition so as to result in a smaller thickness of the coat of the metallic material 13 is exemplified by an increase of a current density or, in the case of using a copper pyrophosphate plating bath, an increase of the P ratio.

The alteration of the plating condition may be made in a shorter time interval so that the amount of the metallic material 13 to be deposited may reduce upward in multiple steps in the coating layer 15. Alternatively, the alteration of the plating condition may be made in a continuous manner so that the amount of the metallic material to be deposited may reduce upward continuously in the coating layer 15. Otherwise, electroplating may be performed at a first current density until the metallic material 13 is deposited in about a lower half of the coating layer 15, and electroplating is further continued at a second current density that is higher than the first current density to deposit the metallic material 13 in about the upper half of the coating layer 15 in an amount smaller than the amount of the metallic material deposited in the lower half. The point of altering the plating condition is not limited to about the middle in the thickness direction of the coating layer 15. That is, the plating condition may be altered to reduce the amount of deposition at a desired time point, for example, at time points corresponding to 10% progress and 90% progress of the plating operation.

In another method, a continuous length of a current collector on which the coating layer 15 has been provided may be successively passed through a plurality of electrolytic cells to achieve penetration plating. In this method, the amount of the metallic material to be deposited in the individual electrolytic cells is controlled by varying the current density for penetration plating between each cells. For example, the current density is gradually increased downstream in the moving direction of the current collector.

The electroplating is stopped at the time when the metallic material 13 is deposited throughout the whole thickness of the coating layer 15. If desired, a surface layer (not shown) may be formed on the active material layer 12 by adjusting the end point of the plating. There is thus obtained a desired negative electrode as illustrated in FIG. 3(d).

The thus obtained negative electrode 10 is well suited for use in nonaqueous secondary batteries, e.g., lithium secondary batteries. In such applications, the positive electrode to be used is obtained as follows. A positive electrode active material and, if necessary, an electroconductive material and a binder are mixed in an appropriate solvent to prepare a positive electrode active material mixture. The active material mixture is applied to a current collector, dried, rolled, and pressed, followed by cutting and punching. Conventional positive electrode active materials can be used, including lithium-containing composite metal oxides, such as lithium-nickel composite oxide, lithium-manganese composite oxide, and lithium-cobalt composite oxide. Also preferred as a positive electrode active material is a mixture of a lithium-transition metal composite oxide comprising LiCoO₂ doped with at least Zr and Mg and a lithium-transition metal composite oxide having a layer structure and comprising LiCoO₂ doped with at least Mn and Ni. Using such a positive electrode active material is promising for increasing a cut-off voltage for charging without reducing the charge/discharge cycle characteristics and thermal stability. The positive electrode active material preferably has an average primary particle size of 5 to 10 μm in view of the balance between packing density and reaction area. Polyvinylidene fluoride having a weight average molecular weight of 350,000 to 2,000,000 is a preferred binder for making the positive electrode; for it is expected to bring about improved discharge characteristics in a low temperature environment.

Preferred separators to be used in the battery include nonwoven fabric of synthetic resins and a porous film of polyolefins, such as polyethylene and polypropylene, or polytetrafluoroethylene. As a separator, for example, a polyethylene porous film (N9420G available from Asahi Kasei Chemicals Corp.) is preferably used. In order to suppress heat generation of the electrode due to overcharge of the battery, it is preferred to use, as a separator, a polyolefin microporous film having a ferrocene derivative thin film on one or both sides thereof. It is preferred for the separator to have a puncture strength of 0.2 to 0.49 N/μm-thickness and a tensile strength of 40 to 150 MPa in the rolling axial direction so that it may have suppress the damage and thereby prevent occurrence of a short circuit even in using a negative electrode active material that undergoes large expansion and contraction with charge/discharge cycles.

The nonaqueous electrolyte is a solution of a lithium salt, a supporting electrolyte, in an organic solvent. Examples of the lithium salt include LiClO₄, LiAlCl₄, LiPF₆, LiAsF₆, LiSbF₆, LiBF₄, LiSCN, LiCl, LiBr, LiI, LiCF₃SO₃ and LiC₄F₉SO₃. Examples of suitable organic solvents include ethylene carbonate, diethyl carbonate, dimethyl carbonate, propylene carbonate, and butylene carbonate. A nonaqueous electrolyte containing 0.5% to 5% by weight of vinylene carbonate, 0.1% to 1% by weight of divinyl sulfone, and 0.1% to 1.5% by weight of 1,4-butanediol dimethane sulfonate based on the total weight of nonaqueous electrolyte is particularly preferred as bringing about further improvement on charge/discharge cycle characteristics. While not necessarily elucidated, the reason of the improvement the inventors believe is that 1,4-butanediol dimethane sulfonate and divinyl sulfone decompose stepwise to form a coating film on the positive electrode, whereby the coating film containing sulfur becomes denser.

For use in the nonaqueous electrolyte, highly dielectric solvents having a dielectric constant of 30 or higher, like halogen-containing, cyclic carbonic ester derivatives, such as 4-fluoro-1,3-dioxolan-2-one, 4-chloro-1,3-dioxolan-2-one, and 4-trifluoromethyl-1,3-dioxolan-2-one, are also preferred because they are resistant to reduction and therefore less liable to decompose. An electrolyte containing a mixture of the highly dielectric solvent and a low viscosity solvent with a viscosity of 1 mPa·s or less, such as dimethyl carbonate, diethyl carbonate, or methyl ethyl carbonate, is also preferred for obtaining higher ionic conductivity. It is also preferred for the electrolyte to contain 14 to 1290 ppm, by mass, of fluoride ion. It is considered that an adequate amount of fluoride ion present in the electrolyte forms a coating film of, for example, lithium fluoride on the negative electrode, which will suppress decomposition of the electrolyte on the negative electrode. It is also preferred for the electrolyte to contain 0.001% to 10% by mass of at least one additive selected from the group consisting of an acid anhydride and a derivative thereof. Such an additive is expected to form a coating film on the negative electrode, which will suppress decomposition of the electrolyte. Exemplary and preferred of such additives are cyclic compounds having a —C(═O)—O—C(═O)— group in the nucleus thereof, including succinic anhydride, glutaric anhydride, maleic anhydride, phthalic anhydride, 2-sulfobenzoic anhydride, citraconic anhydride, itaconic anhydride, diglycolic anhydride, hexafluoroglutaric anhydride; phthalic anhydride derivatives, such as 3-fluorophthalic anhydride and 4-fluorophthalic anhydride; 3,6-epoxy-1,2,3,6-tetrahydrophthalic anhydride, 1,8-naphthalic anhydride, 2,3-naphthalenecarboxylic anhydride; 1,2-cycloalkanedicarboxylic acids, such as 1,2-cycxlopentaneedicarboxylic anhydride and 1,2-cyclohexanedicarboxylic anhydride; tetrahydrophthalic anhydrides, such as cis-1,2,3,6-tetrahydrophthalic anhydride and 3,4,5,6-tetrahydrophthalic anhydride; hexahydrophthalic anhydrides (cis-form and trans-form), 3,4,5,6-tetrachlorophthalic anhydride, 1,2,4-benzenetricarboxylic anhydride, and pyromellitic dianhydride; and derivatives of these acid anhydrides.

### EXAMPLES

The present invention will now be illustrated in greater detail with reference to Examples, but it should be understood that the invention is not construed as being limited thereto.

### Example 1

A 18 μm thick electrolytic copper foil as a current collector was cleaned with an acid at room temperature for 30 seconds and washed with pure water for 15 seconds. A slurry of Si particles was applied to the current collector to a thickness of 15 μm to form a coating layer. The slurry contained the particles, styrene-butadiene rubber (binder), and acetylene black at a weight ratio of 100:1.7:2. The particles had an average particle size D₅₀ of 2 μm. The average particle size D₅₀ was measured using a laser diffraction scattering particle size analyzer Microtrack (Model 9320-X100) from Nikkiso Co., Ltd.

The current collector having the coating layer was immersed in a copper pyrophosphate plating bath having the following composition, and the coating layer was penetration-plated with copper by electrolysis under the following electrolysis conditions to form an active material layer. A DSE was used as an anode, and a direct current power source was used.
Copper pyrophosphate trihydrate: 105 g/l
Potassium pyrophosphate: 450 g/l
Potassium nitrate: 30 g/l
P ratio: 7.7
Bath temperature: 50° C.
Current density: 1 A/dm²
pH: adjusted to 8.2 by the addition of aqueous ammonia and polyphosphoric acid.

When copper was precipitated in the lower half of the thickness of the coating layer, the current density was increased to 3 A/dm², and the penetration plating was continued to deposit copper in the remaining upper half of the coating layer. The penetration plating was stopped at the time when copper was deposited throughout the thickness of the coating layer. A desired negative electrode was thus obtained. The surface of the resulting negative electrode was observed under an electron microscope to find the surface of the active material layer discontinuously coated with copper.

### Comparative Examples 1 and 2

A negative electrode of Comparative Example 1 was fabricated in the same manner as in Example 1, except that the penetration plating with copper was carried out throughout the thickness of the coating layer under a constant condition of a current density of 1 A/dm². A negative electrode of Comparative Example 2 was fabricated in the same manner as in Example 1, except that the penetration plating with copper was carried out throughout the thickness of the coating layer under a constant condition of a current density of 7.5 A/dm².

### Evaluation

The negative electrodes obtained in Example and Comparative Examples were evaluated as follows. The weight per unit area of each of Cu and Si in the whole active material layer was measured with an ICP-AES apparatus. A vertical cross-section was taken of the active material layer, and the ratio of each of Cu and Si in the surface side active material sublayer and the current collector side active material sublayer was measured using an EDX analyzer, Pegasus System from EDAX. The weight per unit area of each of Cu and Si were calculated from the results of these measurements for each of the surface side active material sublayer and the current collector side active material sublayer. The results obtained are shown in Table 1 below. The conditions of measurement with the EDX analyzer were as follows.
Accelerating voltage: 5 kV
Elements under analysis: C, O, F, Cu, Si, and P (the sum of these elements was taken as 100% by weight).
Resolution: 512×400
Frame: 64
Drift correction mode: on

Each of the negative electrodes obtained in Example and Comparative Examples was assembled into a lithium secondary battery together with LiCO_{1/3}Ni_{1/3}Mn_{1/3}O₂ as a positive electrode, an electrolyte prepared by dissolving LiPF₆ in a 1:1 by volume mixed solvent of ethylene carbonate and diethyl carbonate in a concentration of 1 mol/l and externally adding 2% by volume of vinylene carbonate to the solution, and a 20 μm thick polypropylene porous film as a separator. The resulting battery was subjected to first charge, and the voltage at a capacity of 0.1 mAh was measured. The charge was carried out in a cc/cv mode. The results obtained are shown in Table 1. The positive electrode capacity:negative electrode capacity was 2:1; capacity per unit area=3.5 mAh/cm²; charging rate=0.05 C; and total battery capacity=4 mAh.

Each negative electrode obtained in Example and Comparative Examples was evaluated for the adhesion between the active material layer and the current collector as follows. The results are shown in Table 1.

### Evaluation of Adhesion:

In the evaluation, 12 mm wide transparent adhesive tape specified in IS Z1522 was used. The adhesive tape was stuck on its freshly exposed adhesive side to the negative electrode over a length of 50 mm with finger pressure taking care not to entrap air bubbles. After ten seconds, the adhesive tape was quickly peeled at right angles to the negative electrode. The adhesion was rated “good” when the active material layer and the current collector were not separated apart or “ad” when they were separated apart. The peel test was repeated 20 times for each electrode sample obtained in Example and Comparative Examples. The number of the samples rated good was divided by the testing times (=20), and the quotient was multiplied by 100 to give a percent adhesion (%).

TABLE 1

| | | | | | | Adhesion |
|---|---|---|---|---|---|---|
| | | | | | | between the active |
| | | | | | Voltage at | material layer |
| | | Si | Cu | | 1st Charge | and the current |
| | | (g/cm³) | (g/cm³) | Si/Cu | (@0.1 mAh) | collector (%) |
| Example 1 | Surface side | 0.9 | 1.2 | 0.8 | voltage: | 95 |
| | Active Material | | | | 3500 mV | |
| | Sublayer | | | | | |
| | Current | 0.8 | 3.6 | 0.2 | negative | |
| | collector side | | | | electrode | |
| | Active Material | | | | potential: | |
| | Sublayer | | | | 215 mV | |
| Comp. | Surface side | 0.9 | 1.9 | 0.5 | voltage: | 100 |
| Example 1 | Active Material | | | | 3680 mV | |
| | Sublayer | | | | | |
| | Current | 0.9 | 1.9 | 0.5 | negative | |
| | collector side | | | | electrode | |
| | Active Material | | | | potential: | |
| | Sublayer | | | | 36 mV | |
| Comp. | Surface side | 0.9 | 2.0 | 0.5 | voltage: | 25 |
| Example 2 | Active Material | | | | 3540 mV | |
| | Sublayer | | | | | |
| | Current | 0.9 | 1.6 | 0.6 | negative | |
| | collector side | | | | electrode | |
| | Active Material | | | | potential: | |
| | Sublayer | | | | 176 mV | |

As is apparent from the results in Table 1, the negative electrode of Example 1 proves to have a low voltage in the first charge, i.e., a low overpotential. This is ascribable to smooth passage of the nonaqueous electrolyte in the active material layer. The negative electrode of Example 1 also proves to have good adhesion between the active material layer and the current collector. In comparison, it is noted that the negative electrode of Comparative Example 1, while having good adhesion between the active material layer and the current collector, shows a high voltage in the first charge, i.e., a high overpotential. This is considered to be because penetration plating had been performed densely under the low current density so that the most part of the spaces between the Si particles had been filled with copper, resulting in a failure to afford sufficient voids through which the nonaqueous electrolyte was allowed to flow. The negative electrode of Comparative Example 2 has reduced adhesion between the active material layer and the current collector as a result of the coarse penetration plating under a high current density.

The results of SEM observation of the negative electrode of Example 1, while not shown in Table 1, revealed that the copper coat covering the Si particles in the surface side active material sublayer was thinner than that in the current collector side active material sublayer and that the voids between the Si particles in the surface side active material sublayer were bigger than in the current collector side active material sublayer.

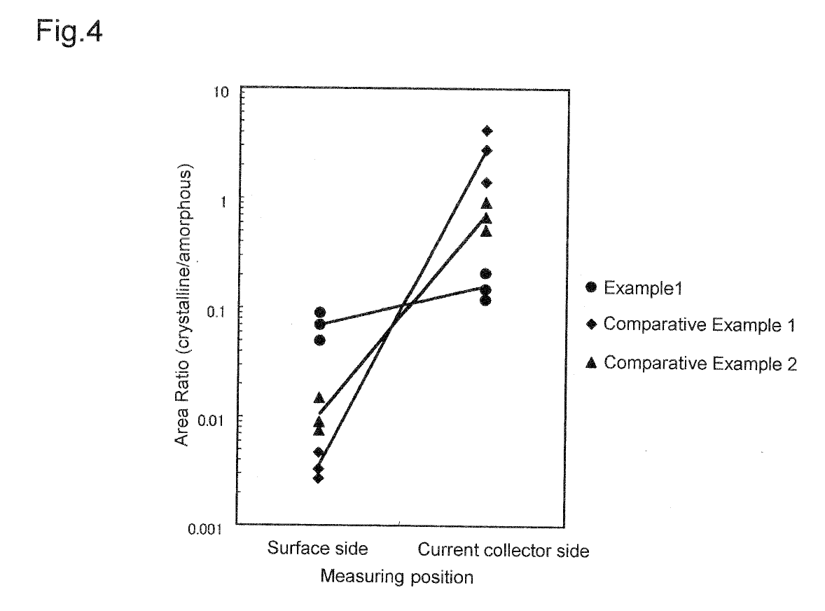

Separately from the above measurement and evaluation, the battery fabricated using each of the negative electrodes obtained in Example and Comparative Examples in the same manner as described above was subjected to one charge/discharge cycle to 50% of the maximum negative electrode capacity. Thereafter, the negative electrode was taken out of the battery and analyzed by Raman spectroscopy at intervals that divide the thickness of the active material layer into 10 equal parts. A laser Raman spectrometer NRS-2100 (trade name) from JASCO Corp. was used, The exciting wavelength was 514.5 nm. The results are shown in FIG. 4.

The results of FIG. 4 afford information about the uniformity of the contribution of the active material to the electrode reaction in the thickness direction. Going into detail, Si changes from crystalline to amorphous phase as a result of an electrode reaction. Raman spectroscopy of Si yields different spectra depending on the difference in crystallinity. Therefore, one can know how much the active material has contributed to an electrode reaction by obtaining the ratio of the Raman spectrum of crystalline phase to that of amorphous phase.

FIG. 4 shows that the negative electrode of Example 1 has a nearly constant ratio of the Raman spectrum of crystalline phase to that of amorphous phase throughout the thickness of its active material layer, verifying that the active material had contributed to the electrode reaction uniformly through its whole thickness. This is ascribable to the smooth passage of the nonaqueous electrolyte through the active material layer. In Comparative Example 1, in contrast, there is much amorphous silicon on the surface side of the active material layer whereas much silicon remains crystalline in the current collector side of the active material layer. This means that the electrode reaction had occurred only on the surface and its vicinity of the active material layer and that the active material existing deep inside the active material layer failed to take part in the electrode reaction. This is believed because the formation of voids allowing the nonaqueous electrolyte to circulate was insufficient.

### INDUSTRIAL APPLICABILITY

According to the present invention, the overpotential in the initial charge can be reduced because a nonaqueous electrolyte containing lithium ions is allowed to easily reach the active material layer. As a result, formation of lithium dendrite on the surface of the negative electrode is prevented; the nonaqueous electrolyte is less likely to decompose thereby to prevent an increase of irreversible capacity; and the positive electrode is protected from damage. Additionally, the negative electrode of the invention has good adhesion between the active material layer and the current collector. The active material hardly falls off even when it pulverizes as a result of expansion and contraction accompanying charge/discharge cycles.

1. A negative electrode for a nonaqueous secondary battery comprising an active material layer containing particles of an active material,
the particles being coated at least partially with a coat of a metallic material having low capability of forming a lithium compound,
the active material layer having voids formed between the metallic material-coated particles,
wherein, when the active material layer is imaginarily divided into equal halves in its thickness direction, the amount of the metallic material is smaller in the half closer to the negative electrode surface than in the other half farther from the negative electrode surface.

2. The negative electrode for a nonaqueous secondary battery according to claim 1, wherein the weight ratio of [the particles/the metallic material] in the half closer to the negative electrode surface is higher than that in the other half farther from the negative electrode surface.

3. The negative electrode for a nonaqueous secondary battery according to claim 1, wherein the particles are distributed almost uniformly in the thickness direction of the active material layer.

4. The negative electrode for a nonaqueous secondary battery according to claim 1, wherein the thickness of the metallic material covering the particles in the half closer to the negative electrode surface is smaller than that in the other half farther from the negative electrode surface.

5. The negative electrode for a nonaqueous secondary battery according to claim 1, wherein the metallic material on the surface of the particles is present throughout the thickness of the active material layer.

6. The negative electrode for a nonaqueous secondary battery according to claim 1, wherein the coat of the metallic material is formed by electroplating in a plating bath having a pH higher than 7.1 and not higher than 11.

7. A nonaqueous secondary battery comprising the negative electrode according to claim 1.

8. A process of producing a negative electrode for a nonaqueous secondary battery comprising the steps of:
applying a slurry containing particles of an active material to a current collector to form a coating layer,
immersing the current collector with the coating layer in a plating bath containing a metallic material having low capability of forming a lithium compound and performing electroplating at a first current density to deposit the metallic material within the coating layer, and then
performing electroplating at a second current density higher than the first current density.

9. The negative electrode for a nonaqueous secondary battery according to claim 2, wherein the particles are distributed almost uniformly in the thickness direction of the active material layer.
